(19) United States
(12) Patent Application Publication
(10) Pub. No.: US 2021/0321362 A1
(43) Pub. Date: Oct. 14, 2021

(54) PREAMBLE TRANSMISSION METHOD AND DEVICE

(71) Applicant: BEIJING XiAOMi MOBILE SOFTWARE CO., LTD., Beijing (CN)

(72) Inventor: Wei HONG, Beijing (CN)

(21) Appl. No.: 17/271,744

(22) PCT Filed: Sep. 4, 2018
(86) PCT No.: PCT/CN2018/104004

§ 371 Date: Feb. 26, 2021

(51) Int. Cl. H04W 68/00; H04W 74/08

(52) U.S. Cl. CPC H04W 68/005; H04W 92/20; H04W 74/0833

(57) ABSTRACT

A preamble transmission method and device, the method comprising: receiving a message sent by a core network, the message being directed to user equipment in an inactive state (101); generating paging signaling, the paging signaling comprising a preamble assigned to the user equipment (102); and sending the paging signaling (103).

### TECHNICAL FIELD

The present disclosure relates to the field of communication technologies, and more particularly, to a method and a device for transmitting a preamble.

### BACKGROUND

In the related art, for user equipment (UE) in an inactive state or an idle state, when the UE needs to send data to a core network, or when the core network needs to send data or signaling to the UE, the UE needs to first complete a random access procedure. The random access procedure includes contention based random access procedure and non-contention based random access procedure. For contention based random access procedure, there is a certain probability that the UE will fail to access, resulting in a delay in connection establishment.

### SUMMARY

Embodiments of the disclosure provide a method and device for transmitting a preamble. The technical solutions are as follows.

According to a first aspect of the embodiments of the present disclosure, a method for transmitting a preamble is provided, which includes that:

a message for a UE in an inactive state is received from a core network;

paging signaling including a preamble allocated for the UE is generated; and

the paging signaling is sent.

The technical solution provided by the embodiments of the present disclosure may include the following beneficial effects: in this embodiment, a base station may send a preamble to a UE in an inactive state in a paging manner, so that the UE in the inactive state may perform random access in a non-contention manner. The success rate of random access of the UE can be effectively improved.

In an embodiment, before generating the paging signaling, the method may further include one of the following operations:

the preamble is received from the core network;

the preamble for the UE is allocated; or

the preamble is received from an operation, administration and maintenance (OAM) device.

The technical solution provided in the embodiments of the present disclosure may include the following beneficial effects: in this embodiment, the preamble can be allocated by multiple devices, which is applicable to multiple application scenarios.

In an embodiment, the operation of sending the paging signaling may include at least one of:

the paging signaling is sent to the UE located within a coverage area of the base station; or

the paging signaling is sent to another base station through an inter-base-station interface.

The technical solution provided in the embodiments of the present disclosure may include the following beneficial effects: in this embodiment, the paging signaling may be directly sent to the UE located within a coverage area of the base station, or the paging signaling can be sent to the UE through another base station, thereby increasing the transmission range and facilitating the UE to receive the paging signaling as required.

In an embodiment, the message may include at least one of a message for data transmission or a message for signaling transmission.

The technical solution provided in the embodiments of the present disclosure may include the following beneficial effects: various messages sent by the core network to the UE in the inactive state may trigger the UE to perform random access.

According to a second aspect of the embodiments of the present disclosure, a method for transmitting a preamble is provided. The method for transmitting the preamble is applied to a base station and includes that:

paging signaling is received from another base station through an inter-base-station interface, the paging signaling including a preamble; and

the paging signaling is sent.

In an embodiment, the operation of sending the paging signaling may include at least one of:

the paging signaling is sent to a UE located within a coverage area of the base station; or

the paging signaling is sent to the another base station through the inter-base-station interface.

According to a third aspect of the embodiments of the present disclosure, a method for transmitting a preamble is provided. The method is applied to a UE in an inactive state and includes that:

paging signaling is received from a base station, the paging signaling including a preamble; and

a random access request is sent to the base station, the random access request including the preamble.

According to a fourth aspect of the embodiments of the present disclosure, a method for transmitting a preamble is provided. The method is applied to a core network and includes that:

a message for a UE in an inactive state is sent to a base station; and

a preamble allocated for the UE is sent to the base station.

According to a fifth aspect of the embodiments of the present disclosure, a device for transmitting a preamble is provided and applied to a base station. The device includes a first receiving module, a generation module, and a sending module.

The first receiving module is configured to receive a message for a UE in an inactive state from a core network.

The generation module is configured to generate paging signaling including a preamble allocated for the UE.

The sending module is configured to send the paging signaling.

In an embodiment, the device may further include one of a second receiving module, an allocation module, or a third receiving module.

The second receiving module is configured to receive the preamble from the core network.

The allocation module is configured to allocate the preamble for the UE.

The third receiving module is configured to receive the preamble from an OAM device.

In an embodiment, the sending module may include at least one of a first sending sub-module or a second sending sub-module.

The first sending sub-module is configured to send the paging signaling to the UE located within a coverage area of the base station.

The second sending sub-module is configured to send the paging signaling to another base station through an inter-base-station interface.

In an embodiment, the message may include at least one of a message for data transmission or a message for signaling transmission.

According to a sixth aspect of the embodiments of the present disclosure, a device for transmitting a preamble is provided and applied to a base station. The device includes a receiving module and a sending module.

The receiving module is configured to receive a paging signaling from another base station through an inter-base-station interface; herein, the paging signaling includes a preamble.

The sending module is configured to send the paging signaling.

In an embodiment, the sending module may include at least one of a first sending sub-module or a second sending sub-module.

The first sending sub-module is configured to send the paging signaling to a UE located within a coverage area of the base station.

The second sending sub-module is configured to send the paging signaling to the another base station through the inter-base-station interface.

According to a seventh aspect of the embodiments of the present disclosure, a device for transmitting a preamble is provided and applied to a UE in an inactive state. The device includes a receiving module and a sending module.

The receiving module is configured to receive a paging signaling from a base station; herein, the paging signaling includes a preamble,

The sending module is configured to send a random access request to the base station; herein, the random access request includes the preamble.

According to an eighth aspect of the embodiments of the present disclosure, a device for transmitting a preamble is provided and applied to a core network. The device includes a first sending module and a second sending module.

The first sending module is configured to send a message for a UE in an inactive state to a base station.

The second sending module is configured to send a preamble allocated for the UE to the base station.

According to a ninth aspect of the embodiments of the present disclosure, a device for transmitting a preamble is provided, which includes:

a processor; and

a memory for storing instructions executable by the processor.

The processor is configured to:

receive a message for a UE in an inactive state from a core network;

generate paging signaling including a preamble allocated for the UE; and

send the paging signaling.

According to a tenth aspect of the embodiments of the present disclosure, a device for transmitting a preamble is provided, which includes:

a processor; and

a memory for storing instructions executable by the processor.

The processor is configured to:

receive paging signaling from another base station through an inter-base-station interface, the paging signaling including a preamble; and

send the paging signaling.

According to an eleventh aspect of the embodiments of the present disclosure, a device for transmitting a preamble is provided, which includes:

a processor; and

a memory for storing instructions executable by the processor.

The processor is configured to:

receive a paging signaling from a base station, the paging signaling including a preamble; and

send a random access request to the base station, the random access request including the preamble.

According to a twelfth aspect of the embodiments of the present disclosure, a device for transmitting a preamble is provided, which includes:

a processor; and

a memory for storing instructions executable by the processor.

The processor is configured to:

send a message for a UE in an inactive state to a base station; and

send a preamble allocated for the UE to the base station.

According to a thirteenth aspect of the embodiments of the present disclosure, a computer-readable storage medium is provided, which is configured to store therein computer instructions that, when executed by a processor, cause the processor to perform the method for generating paging signaling by a base station as described above.

According to a fourteenth aspect of the embodiments of the present disclosure, a computer-readable storage medium is provided, which is configured to store therein computer instructions that, when executed by a processor, cause the processor to perform the method for transmitting paging signaling by a base station as described above.

According to a fifteenth aspect of the embodiments of the present disclosure, a computer-readable storage medium is provided, which is configured to store therein computer instructions that, when executed by a processor, cause the processor to perform the method applied to a UE as described above.

According to a sixteenth aspect of the embodiments of the present disclosure, a computer-readable storage medium is provided, which is configured to store therein computer instructions that, when executed by a processor, cause the processor to perform the method applied on a core network as described above.

It is to be understood that the foregoing general descriptions and detailed descriptions below are only exemplary and explanatory and not intended to limit the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart of a method for transmitting a preamble according to an exemplary embodiment.

FIG. 2 is a flowchart of a method for transmitting a preamble according to an exemplary embodiment.

FIG. 3 is a flowchart of a method for transmitting a preamble according to an exemplary embodiment.

FIG. 4 is a flowchart of a method for transmitting a preamble according to an exemplary embodiment.

FIG. 5 is a flowchart of a method for transmitting a preamble according to an exemplary embodiment.

FIG. 6 is a block diagram of a device for transmitting a preamble according to an exemplary embodiment.

FIG. 7 is a block diagram of a device for transmitting a preamble according to an exemplary embodiment.

FIG. 8 is a block diagram of a sending module according to an exemplary embodiment.

FIG. 9 is a block diagram of a device for transmitting a preamble according to an exemplary embodiment.

FIG. 10 is a block diagram of a sending module according to an exemplary embodiment.

FIG. 11 is a block diagram of a device for transmitting a preamble according to an exemplary embodiment.

FIG. 12 is a block diagram of a device for transmitting a preamble according to an exemplary embodiment.

FIG. 13 is a block diagram of a device suitable for transmitting a preamble according to an exemplary embodiment.

FIG. 14 is a block diagram of a device suitable for transmitting a preamble according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

In the related art, for a UE in an inactive state or an idle state, when the UE needs to send data to a core network, or when the core network needs to send data or signaling to the UE, the UE needs to first complete a random access procedure. The random access procedure includes contention based random access procedure and non-contention based random access procedure. For contention based random access procedure, there is a certain probability that the UE will fail to access, resulting in a delay in connection establishment.

To solve the above problem, in this embodiment, when a base station receives a message sent by a core network to a UE in an inactive state, the base station sends a preamble to the UE through paging signaling, and the UE can perform non-contention based random access according to the preamble, thereby improving a success rate of the random access, so that the UE receives the message.

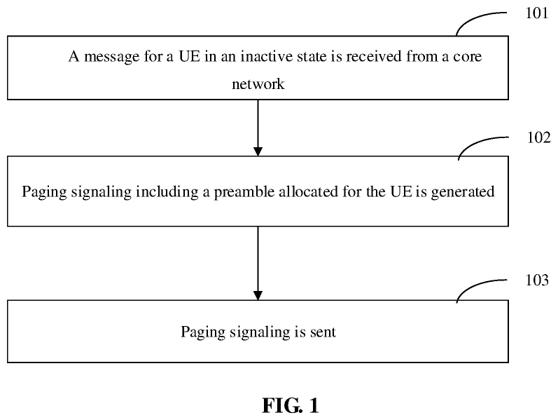

FIG. 1 is a flowchart of a method for transmitting a preamble according to an exemplary embodiment. The method for transmitting the preamble is applied to an access network device such as a base station. As illustrated in FIG. 1, the method includes the following operations illustrated in blocks 101 to 103.

At block 101, a message for a UE in an inactive state is received from a core network.

At block 102, paging signaling including a preamble allocated for the UE is generated.

At block 103, the paging signaling is sent.

In this embodiment, the state of the UE includes an idle state, an inactive state, and an active state. For a UE in an inactive state, it does not maintain real-time synchronization with the core network during movement. Therefore, the base station that receives the message sent by the core network is the last base station, determined by the core network according to the context of the UE stored locally, that serves the UE.

The message may be a notification message used for notifying the base station to send paging signaling. Both the notification message and the paging signaling include an identifier of the UE. Alternatively, the message is a message to be sent by the core network to the UE. In an embodiment, the message may include at least one of a message for data transmission or a message for signaling transmission.

After receiving the message, the base station does not first send the message to the UE because the base station does not know whether the UE is located within its own coverage area. In this embodiment, the base station first sends paging signaling including a preamble allocated for the UE to the UE, which can trigger the UE to perform non-contention based random access. After accessing the cell, that is, when the UE is in the active state, the message is sent to the UE.

In this embodiment, a base station may send a preamble to a UE in a paging manner, so that the UE performs non-contention based random access, thereby improving a success rate of the random access and facilitating communication between the UE and a network more timely.

In an embodiment, the method may further include one of operation A1, operation A2, or operation A3.

In A1, the preamble sent by the core network is received.

In this embodiment, the core network may carry a preamble in the message, and the preamble is used for the UE to which the message is directed. Alternatively, the core network sends one or more preambles to the base station. When the base station needs to generate paging signaling, a preamble is selected therefrom. The core network may send the preamble to the base station before or after sending the message. If the preamble is transmitted after the message transmission, the base station can generate paging signaling only after receiving the preamble.

In A2, the preamble for the UE is allocated.

In this embodiment, the base station may allocate a preamble for the UE to which the message is directed.

In A3, the preamble is received from an OAM device.

In this embodiment, the OAM may send one or more preambles to the base station in advance. When the base station needs to generate paging signaling, a preamble is selected therefrom.

In an embodiment, operation illustrated in block 103 may include at least one of operation B1 or operation B2.

In B1, the paging signaling is sent to the UE located within a coverage area of the base station.

In B2, the paging signaling is sent to another base station through an inter-base-station interface.

In this embodiment, the base station sends the paging signaling to the UE located within a coverage area of the base station. However, a UE in an inactive state may move to another position beyond the coverage area of the base station. Therefore, in order to make the paging signaling better reach the UE, the base station may also send paging signaling to another base station. The inter-base-station paging signaling transmission may be implemented through an inter-base-station interface (e.g., an Xn interface). The base station and the another base station belong to the same RNA (i.e., RAN Notification Area). The another base station that receives paging signaling may continue to send the paging signaling to UE located within its own coverage area and to other base stations through the inter-base-station interface. That is to say, in this embodiment, paging signaling can be sent within the RNA range, which is facilitated for the UE to receive paging signaling in time.

The base station may also send the message to another base station so that the base station (i.e., the base station currently serving the UE) may send the message to the UE after the random access of the UE is successful.

The implementation processes will be described in detail in combination with embodiments hereinafter.

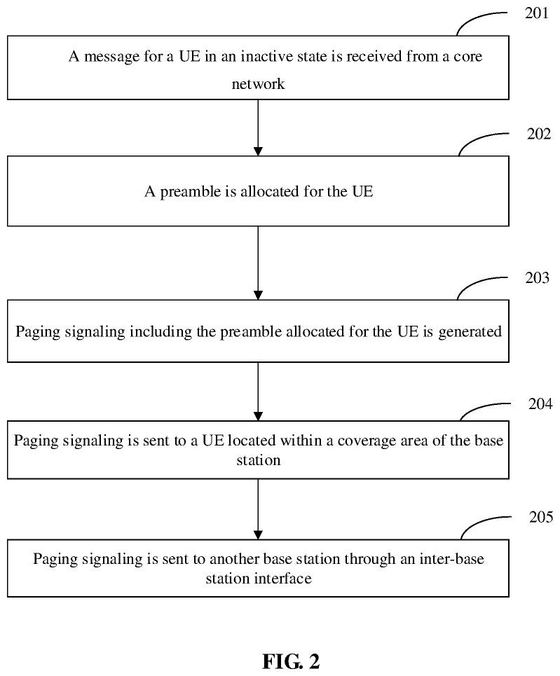

FIG. 2 is a flowchart of a method for transmitting a preamble according to an exemplary embodiment. The method for transmitting the preamble is applied to an access network device such as a base station. As illustrated in FIG. 2, the method includes the following operations illustrated in blocks 201 to 205.

At block 201, a message for a UE in an inactive state is received from a core network.

At block 202, a preamble is allocated for the UE.

At block 203, paging signaling including the preamble allocated for the UE is generated.

At block 204, the paging signaling is sent to a UE located within a coverage area of the base station.

At block 205, the paging signaling is sent to another base station through an inter-base-station interface.

The base station described in this embodiment is a base station that receives a message from a core network. In other scenarios, the base station may also serve as another base station, that is, a base station that receives paging signaling. The implementation of this scenario is described below.

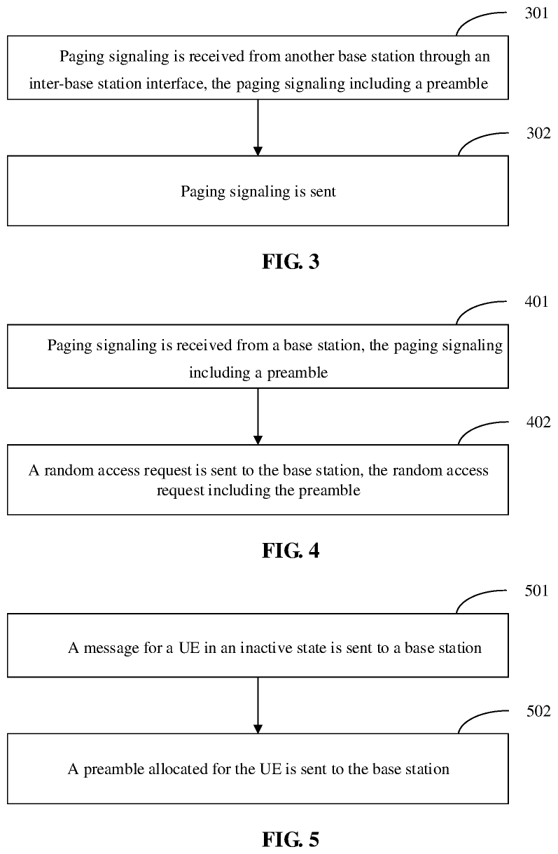

FIG. 3 is a flowchart of a method for transmitting a preamble according to an exemplary embodiment. The method for transmitting the preamble is applied to an access network device such as a base station. As illustrated in FIG. 3, the method includes the following operations illustrated in blocks 301 and 302.

At block 301, paging signaling is received from another base station through an inter-base-station interface; herein, the paging signaling includes a preamble.

At block 302, the paging signaling is sent.

In this embodiment, the base station may immediately forward the paging signaling after receiving the paging signaling, so that the paging signaling arrives at the UE in a more timely manner.

In an embodiment, operation illustrated in block 302 may include at least one of operation C1 or operation C2.

In C1, the paging signaling is sent to the UE located within a coverage area of the base station.

In C2, the paging signaling is sent to another base station through an inter-base-station interface.

In this embodiment, the base station sends the paging signaling to the UE located within a coverage area. However, a UE in an inactive state may move to another position beyond the coverage area of the base station. Therefore, the base station may also send paging signaling to another base station in order to make the paging signaling better reach the UE, which is facilitated to send paging signaling within the RNA range.

The implementation process of the base station side is described above, while the UE side has corresponding improvement. The implementation process of the UE side is described below.

FIG. 4 is a flowchart of a method for transmitting a preamble according to an exemplary embodiment. The method for transmitting the preamble is applied to a UE. The UE may be a mobile phone, a computer, a digital broadcast terminal, a messaging device, a game console, a tablet device, a medical device, an exercise device, a personal digital assistant, and the like. As illustrated in FIG. 4, the method includes the following operations illustrated in blocks 401 and 402.

At block 401, paging signaling is received from a base station, herein the paging signaling includes a preamble.

At block 402, a random access request is sent to the base station, herein the random access request includes the preamble.

In this embodiment, the UE is a UE in an inactive state, and can receive and parse paging signaling carrying a preamble. The UE performs a non-contention based random access when triggered by the paging signaling, and sends a random access request message carrying the preamble. The success rate of random access of the UE is improved so that the UE receives subsequent messages more timely.

FIG. 5 is a flowchart of a method for transmitting a preamble according to an exemplary embodiment. The method for transmitting the preamble is applied to a core network. As illustrated in FIG. 5, the method includes the following operations illustrated in blocks 501 and 502.

At block 501, a message for a UE in an inactive state is sent to a base station.

At block 502, a preamble allocated for the UE is sent to the base station.

In this embodiment, when the core network needs to send a message to the UE in the inactive state, the core network sends the preamble allocated for the UE to the base station. The core network has the function of sending a preamble to a base station. Operations illustrated in blocks 501 and 502 may be implemented through a message, i.e., a message that carries a preamble. It can also be implemented by two messages, and the execution order can be interchanged.

The above embodiments may be combined freely according to actual needs.

The following are embodiments of the apparatus of the present disclosure, which can be used for performing the methods according to the embodiments of the present disclosure.

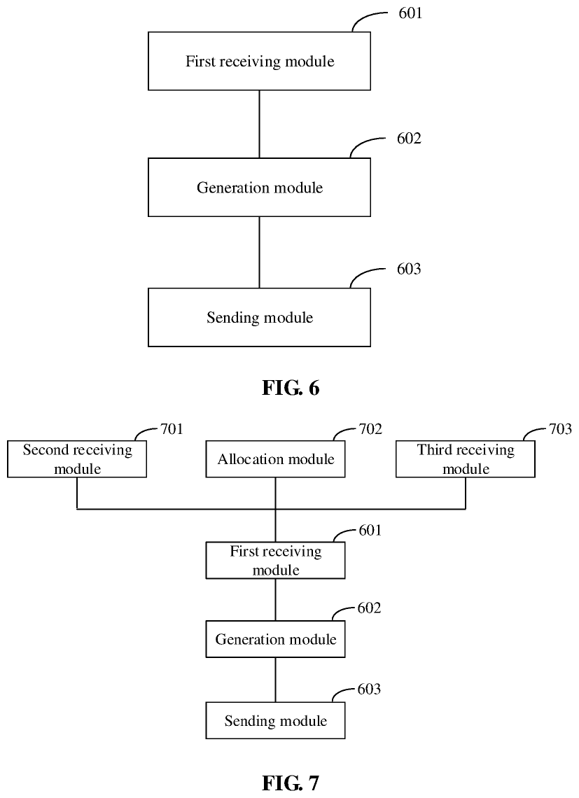

FIG. 6 is a block diagram of a device for transmitting a preamble according to an exemplary embodiment. The device is applied to a base station. The device may be implemented as part or all of an electronic device by software, hardware, or a combination of both. Referring to FIG. 6, the device for transmitting a preamble includes a first receiving module 601, a generation module 602, and a sending module 603.

The first receiving module 601 is configured to receive a message for a UE in an inactive state from a core network.

The generation module 602 is configured to generate paging signaling including a preamble allocated for the UE.

The sending module 603 is configured to send the paging signaling.

In an embodiment, as illustrated in FIG. 7, the device may further include one of a second receiving module 701, an allocation module 702, or a third receiving module 703.

The second receiving module 701 is configured to receive the preamble from the core network.

The allocation module 702 is configured to allocate the preamble for the UE.

The third receiving module 703 is configured to receive the preamble from an OAM device.

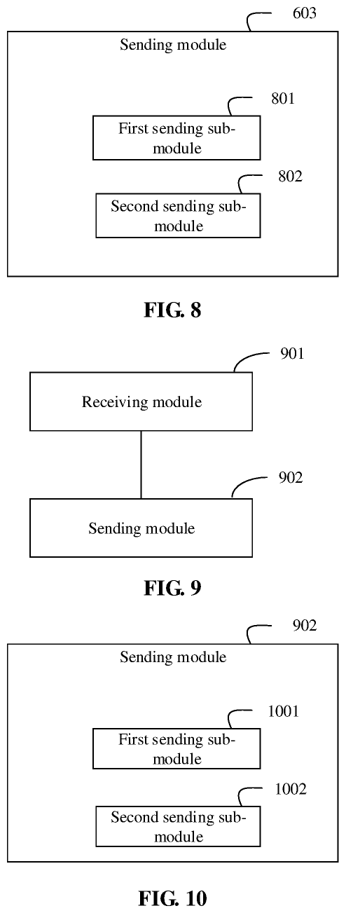

In an embodiment, as illustrated in FIG. 8, the sending module 603 may include at least one of a first sending sub-module 801 or a second sending sub-module 802.

The first sending sub-module 801 is configured to send the paging signaling to the UE located within a coverage area of the base station.

The second sending sub-module 802 is configured to send the paging signaling to another base station through an inter-base-station interface.

In an embodiment, the message may include at least one of a message for data transmission or a message for signaling transmission.

FIG. 9 is a block diagram of a device for transmitting a preamble according to an exemplary embodiment. The device is applied to a base station. The device may be implemented as part or all of an electronic device by software, hardware, or a combination of both. Referring to FIG. 9, the device for transmitting a preamble includes a receiving module 901 and a sending module 902.

The receiving module 901 is configured to receive a paging signaling from another base station through an inter-base-station interface, herein the paging signaling includes a preamble.

The sending module 902 is configured to send the paging signaling.

In an embodiment, as illustrated in FIG. 10, the sending module 902 may include at least one of a first sending sub-module 1001 or a second sending sub-module 1002.

The first sending sub-module 1001 is configured to send the paging signaling to a UE located within a coverage area of the base station.

The second sending sub-module 1002 is configured to send the paging signaling to another base station through an inter-base-station interface.

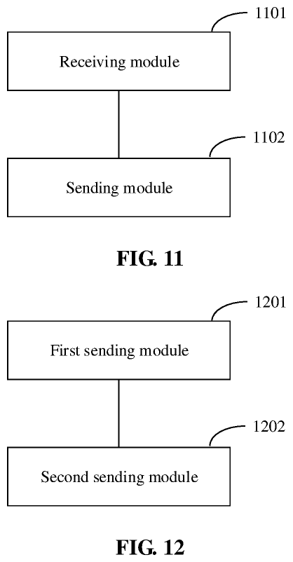

FIG. 11 is a block diagram of a device for transmitting a preamble according to an exemplary embodiment. The device is applied to a UE in an inactive state. The device may be implemented as part or all of an electronic device by software, hardware, or a combination of both. Referring to FIG. 11, the device for transmitting a preamble includes a receiving module 1101 and a sending module 1102.

The receiving module 1101 is configured to receive a paging signaling from a base station, herein the paging signaling includes a preamble.

The sending module 1102 is configured to send a random access request to the base station, herein the random access request includes the preamble.

FIG. 12 is a block diagram of a device for transmitting a preamble according to an exemplary embodiment. The device is applied to a core network. The device may be implemented as part or all of an electronic device by software, hardware, or a combination of both. Referring to FIG. 12, the device for transmitting a preamble includes a first sending module 1201 and a second sending module 1202.

The first sending module 1201 is configured to send a message for a UE in an inactive state to a base station.

The second sending module 1202 is configured to send a preamble allocated for the UE to the base station.

With respect to the devices in the above embodiments, the specific manners for performing operations for individual modules therein have been described in detail in the embodiments regarding the methods for transmitting a preamble, which will not be elaborated herein.

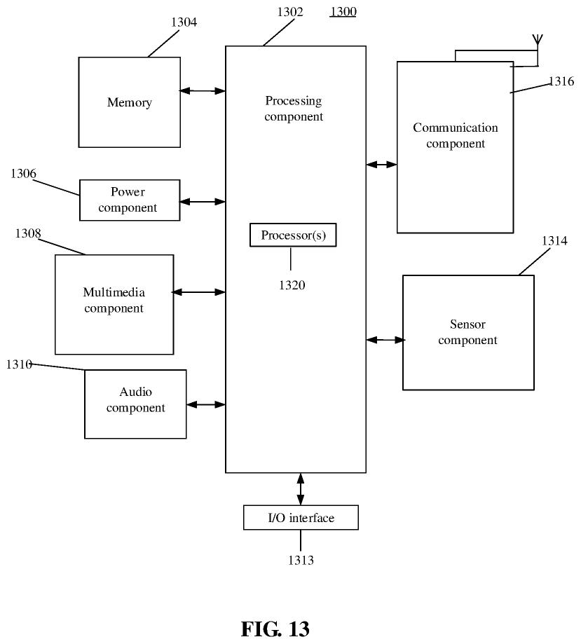

FIG. 13 is a block diagram of a device for transmitting a preamble according to an exemplary embodiment. For example, a device 1300 may be a mobile phone, a computer, a digital broadcast terminal, a messaging device, a gaming console, a tablet, a medical device, exercise equipment, a personal digital assistant, and the like.

The device 1300 may include one or more of the following components: a processing component 1302, a memory 1304, a power component 1306, a multimedia component 1308, an audio component 1310, an input/output (I/O) interface 1313, a sensor component 1314, and a communication component 1316.

The processing component 1302 typically controls the overall operations of the device 1300, such as the operations associated with displays, telephone calls, data communications, camera operations, and recording operations. The processing component 1302 may include one or more processors 1320 to execute instructions to perform all or a part of the operations in the methods described above. Moreover, the processing component 1302 may include one or more modules which facilitate interaction between the processing component 1302 and other components. For instance, the processing component 1302 may include a multimedia module to facilitate interaction between the multimedia component 1308 and the processing component 1302.

The memory 1304 is configured to store various types of data to support the operation of the device 1300. Examples of such data include instructions for any application or methods operated on the device 1300, contact data, phonebook data, messages, pictures, video, etc. The memory 1304 may be implemented using any type of volatile or non-volatile memory devices or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the device 1300. The power component 1306 may include a power management system, one or more power supplies, and any other components associated with the generation, management, and distribution of power in the device 1300.

The multimedia component 1308 includes a screen providing an output interface between the device 1300 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundary of a touch or swipe action, but also sense a period of time and a pressure associated with the touch or swipe action. In some embodiments, the multimedia component 1308 includes a front camera and/or a rear camera. The front camera and the rear camera may receive an external multimedia datum while the device 1300 is in an operating mode, such as a photographing mode or a video mode. Each of the front and rear camera may be a fixed optical lens system or have a focus and optical zoom capability.

The audio component 1310 is configured to output and/or input audio signals. For example, the audio component 1310 includes a microphone (“MIC”) configured to receive an external audio signals when the device 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1313 provides an interface between the processing component 1302 and peripheral interface modules, such as a keyboard, a click wheel, buttons, and the like. These buttons may include, but are not limited to, a home button, a volume button, a starting button, and a locking button.

The sensor component 1314 includes one or more sensors to provide status assessment of various aspects of the device 1300. For instance, the sensor component 1314 may detect an open/closed status of the device 1300, relative positioning of components, e.g., the display and the keypad, of the device 1300, a change in position of the device 1300 or a component of the device 1300, a presence or absence of user contact with the device 1300, an orientation or acceleration/deceleration of the device 1300, and a change in temperature of the device 1300. The sensor component 1314 may include a proximity sensor configured to detect the presence of nearby objects without any physical contact. The sensor component 1314 may also include a light sensor, such as a complementary metal-oxide-semiconductor (CMOS) or charge-coupled device (CCD) image sensor, for use in imaging applications. In some embodiments, the sensor component 1314 may also include an accelerometer sensor, a gyroscope sensor, a magnetic sensor, a pressure sensor, or a temperature sensor.

The communication component 1316 is configured to facilitate wired or wireless communication between the device 1300 and other devices. The device 1300 may access a wireless network based on a communication standard, such as wireless fidelity (WiFi), 2G, or 3G, or a combination thereof. In one exemplary embodiment, the communication component 1316 receives broadcast signals or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1300 may be implemented by one or more application specific integrated circuits (ASICs), digital signal processors (DSPs), digital signal processing devices (DSPD), programmable logic devices (PLDs), field programmable gate arrays (FPGAs), controllers, micro-controllers, microprocessors, or other electronic components, for performing the methods described above.

In exemplary embodiments, a non-transitory computer-readable storage medium including instructions, such as memory 1304 including instructions executable by processor 1320 of device 1300 to perform the above-described methods, is also provided. For example, the non-transitory computer-readable storage medium may be a ROM, a random access memory (RAM), a compact disc read-only memory (CD-ROM), a magnetic tape, a floppy disk, an optical data storage device, and the like.

In exemplary embodiments, a device for transmitting a preamble is provided, which includes:

a processor; and

a memory for storing instructions executable by the processor;

the processor is configured to:

receive a paging signaling from a base station, the paging signaling including a preamble; and

send a random access request to the base station, the random access request including the preamble.

A computer-readable storage medium is provided, which is configured to store therein instructions that, when executed by a processor, cause the processor to perform the method for transmitting a preamble as described above, and the method includes that:

paging signaling is received from a base station, the paging signaling including a preamble; and

a random access request is sent to the base station, the random access request including the preamble.

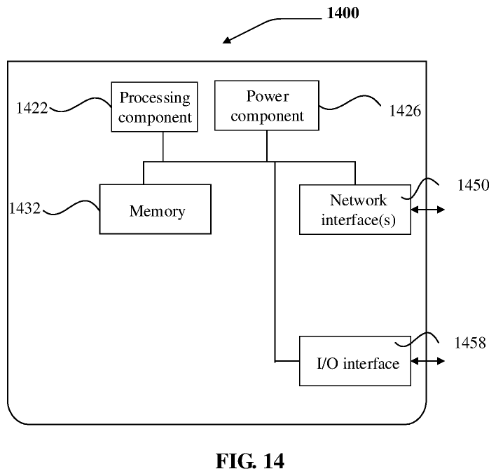

FIG. 14 is a block diagram of a device 1400 for synchronizing data according to an exemplary embodiment. For example, the device 1400 may be provided as a computer. Referring to FIG. 14, the device 1400 includes a processing component 1422 including one or more processors, and memory resources represented by memory 1432, for storing instructions, such as applications, that may be executed by processing component 1422. The application stored in memory 1432 may include one or more modules each corresponding to a set of instructions. Further, the processing component 1422 is configured to execute instructions to perform the above described method for synchronizing data.

The device 1400 may also include a power component 1426 configured to perform power management of the device 1400, a wired or wireless network interfaces 1450 configured to connect the device 1400 to a network, and an input/output (I/O) interface 1458. The device 1400 may operate based on an operating system stored in memory 1432, such as Windows Server™, Mac OS X™, Unix™, Linux™, FreeBSD™, or the like.

In exemplary embodiments, a device for transmitting a preamble is provided, which includes:

a processor; and

a memory for storing instructions executable by the processor;

the processor is configured to:

receive a message for a UE in an inactive state from a core network;

generate paging signaling including a preamble allocated for the UE; and

send the paging signaling.

The processor may also be configured to: before generating the paging signaling, perform one of the following operations:

receiving the preamble from the core network;

allocating the preamble for the UE; or

receiving the preamble from an OAM device.

The processor may also be configured to send the paging signaling.

Specifically, the processor is further configured to: send the paging signaling to the UE located within a coverage area of the base station; and/or, send the paging signaling to another base station through an inter-base-station interface.

The message may include at least one of a message for data transmission or a message for signaling transmission.

A computer-readable storage medium is provided, which is configured to store therein instructions that, when executed by a processor, cause the processor to perform the method for transmitting a preamble as described above, and the method includes that:

a message for a UE in an inactive state is received from a core network;

paging signaling including a preamble allocated for the UE is generated; and

the paging signaling is sent.

The instructions in the storage medium may further cause the processor to perform one of the following operations before generating the paging signaling:

the preamble is received from the core network;

the preamble is allocated for the UE; and

the preamble is received from an OAM device.

The instructions in the storage medium may further cause the processor to perform at least one of the following operations:

the paging signaling is sent to the UE located within a coverage area of the base station; or

the paging signaling is sent to another base station through an inter-base-station interface.

The message may include at least one of a message for data transmission or a message for signaling transmission.

In exemplary embodiments, a device for transmitting a preamble is provided, which includes:

a processor; and

a memory for storing instructions executable by the processor;

the processor is configured to:

receive paging signaling from another base station through an inter-base-station interface, the paging signaling including a preamble; and

send the paging signaling.

The processor may also be configured to send the paging signaling by performing at least one of the following operations:

the paging signaling is sent to the UE located within a coverage area of the base station; or

the paging signaling is sent to another base station through an inter-base-station interface.

A computer-readable storage medium is provided, which is configured to store therein instructions that, when executed by a processor, cause the processor to perform the method for transmitting a preamble as described above, and the method includes that:

paging signaling is received from another base station through an inter-base-station interface, the paging signaling including a preamble; and

the paging signaling is sent.

The instructions in the storage medium may further cause the processor to perform at least one of the following operations:

the paging signaling is sent to the UE located within a coverage area of the base station; or

the paging signaling is sent to another base station through an inter-base-station interface.

In exemplary embodiments, a device for transmitting a preamble is provided, which includes:

a processor; and

a memory for storing instructions executable by the processor;

the processor is configured to:

send a message for a UE in an inactive state to a base station; and

send a preamble allocated for the UE to the base station.

A computer-readable storage medium is provided, which is configured to store therein instructions that, when executed by a processor, cause the processor to perform the method for transmitting a preamble as described above, and the method includes that:

a message for a UE in an inactive state is sent to a base station; and

a preamble allocated for the UE is sent to the base station.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A method for transmitting a preamble, implemented by a base station, the method comprising:
receiving, from a core network, a message for user equipment (UE) in an inactive state;
generating paging signaling comprising a preamble allocated for the UE; and
sending the paging signaling.

2. The method of claim 1, wherein before generating the paging signaling, the method further comprises one of:
receiving the preamble from the core network;
allocating the preamble for the UE; or
receiving the preamble from an operation, administration and maintenance (OAM) device.

3. The method of claim 1, wherein sending the paging signaling comprises at least one of:
sending the paging signaling to the UE located within a coverage area of the base station; or
sending the paging signaling to another base station through an inter-base-station interface.

4. The method of claim 1, wherein the message comprises at least one of:
a message for data transmission; or
a message for signaling transmission.

5. A method for transmitting a preamble, implemented by a base station, the method comprising:
receiving paging signaling from another base station through an inter-base-station interface, wherein the paging signaling comprises a preamble; and
sending the paging signaling.

6. The method of claim 5, wherein sending the paging signaling comprises at least one of:
sending the paging signaling to user equipment (UE) located within a coverage area of the base station; or
sending the paging signaling to the another base station through the inter-base-station interface.

7. A base station, comprising:
a communication component, configured to receive, from a core network, a message for user equipment (UE) in an inactive state; and
a processing component, configured to generate paging signaling comprising a preamble allocated for the UE;
wherein the communication component is further configured to send the paging signaling.

8. The base station of claim 7, wherein one of the following applies:
the communication component is further configured to receive the preamble from the core network;
the processing component is further configured to allocate the preamble for the UE; or
the communication component is further configured to receive the preamble from an operation, administration and maintenance (OAM) device.

9. The base station of claim 7, wherein the communication component is further configured to perform operations comprising one of:
sending the paging signaling to the UE located within a coverage area of the base station; or
sending the paging signaling to another base station through an inter-base-station interface.

10. The base station of claim 7, wherein the message comprises at least one of:
a message for data transmission; or
a message for signaling transmission.

11. A base station, comprising:
a communication component, configured to implement the method for transmitting the preamble of claim 5.

12. The base station of claim 11, wherein the communication component is further configured to perform operations comprising at least one of:
sending the paging signaling to user equipment (UE) located within a coverage area of the base station; or
sending the paging signaling to the another base station through the inter-base-station interface.

13.-16. (canceled)
